(19) United States
(12) Patent Application Publication
(10) Pub. No.: US 2005/0012277 A1
(43) Pub. Date: Jan. 20, 2005

(54) Sealing ring for a fluid circuit

(76) Inventors: David Adrion, Roanne (FR); Michel Maquaire, Ardon (FR)

Correspondence Address: OLIFF & BERRIDGE, PLC, P.O. BOX 19928, ALEXANDRIA, VA, 22320, US

(21) Appl. No.: 10/495,603

(22) PCT Filed: Oct. 17, 2002
(86) PCT No.: PCT/FR02/03553

(30) Foreign Application Priority Data
Nov. 14, 2001 (FR) 01/14695

(51) Int. Cl. F16J 15/32

(52) U.S. Cl. 277/549

(57) ABSTRACT

A sealing system for a shaft revolving in a pressurized fluid circuit. The system comprises a sealing ring placed between the revolving shaft and a fixed casing comprising a deformable element that is applied tightly against said shaft. The deformable element is made of a heat-sensitive shape memory material and being sensitive to a build up in temperature.

The technical scope of the present invention is that of sealing systems between a revolving shaft and its housing.

In this type of assembly, sealing systems are constituted by seals in the shape of single or double lipped rings applied to the periphery of the shaft. More often than not these rings ensure permanent sealing. When these are mounted with parts in motion, this function is ensured by the friction of the part in motion, that is to say the shaft, on a fixed part. It is easy to understand that this permanent friction generates wear on the seal, thereby reducing sealing effectiveness over time. The seal then has to be replaced, which requires the disassembly of the system. Furthermore, this problem is particularly damaging when considering piping where the circulation of a fluid is made intermittently at a low functioning rate with respect to the time taken for the parts of the system to start moving. Once again, it is easy to understand that the needless permanent friction is prejudicial to the useful life of these seals.

The aim of the present invention is to provide a sealing system for a shaft revolving in a pressurized fluid circuit that ensures its function only when directly solicited by an operator, so as to increase its useful life.

The invention thus relates to a sealing system for a shaft revolving in a pressurized fluid circuit, wherein it comprises a sealing ring placed between the revolving shaft and a fixed casing comprising a deformable element that is applied tightly against said shaft.

According to one characteristic of the invention, the deformable element is made of a heat-sensitive shape memory material.

According to yet another characteristic of the invention, the deformable element is sensitive to a build up in temperature.

According to yet another characteristic of the invention, the ring is provided with at least one lip whose deformable element directly ensures its application on to said shaft.

According to yet another characteristic of the invention, the ring is in the form of a U-shaped revolving part, the deformable element being constituted by the inner branch of the U.

Advantageously, the ring is force-fitted into a casing at its external branch.

According to another characteristic of the invention, the ring only has one lip.

According to another characteristic of the invention, the inner branch of the U is subjected to the action of a toric spring applying a starting pressure determined by the revolving shaft.

A first advantage of the system according to the invention lies in the very simple design of the sealing ring, the pressure it applies to the revolving shaft being able to be controlled at will.

Another advantage lies in the fact that when not in use the friction stress is limited, thereby extending the useful life of the ring and requiring it to be replaced only occasionally.

Another advantage lies in the fact that a ring may be made that is provided with a single sealing lip for application on pressurized and depressurized fluid piping in place of a double-lipped ring.

Other characteristics, details and particulars of the invention will become more apparent from the description given hereafter by way of illustration and in reference to the drawings, in which:

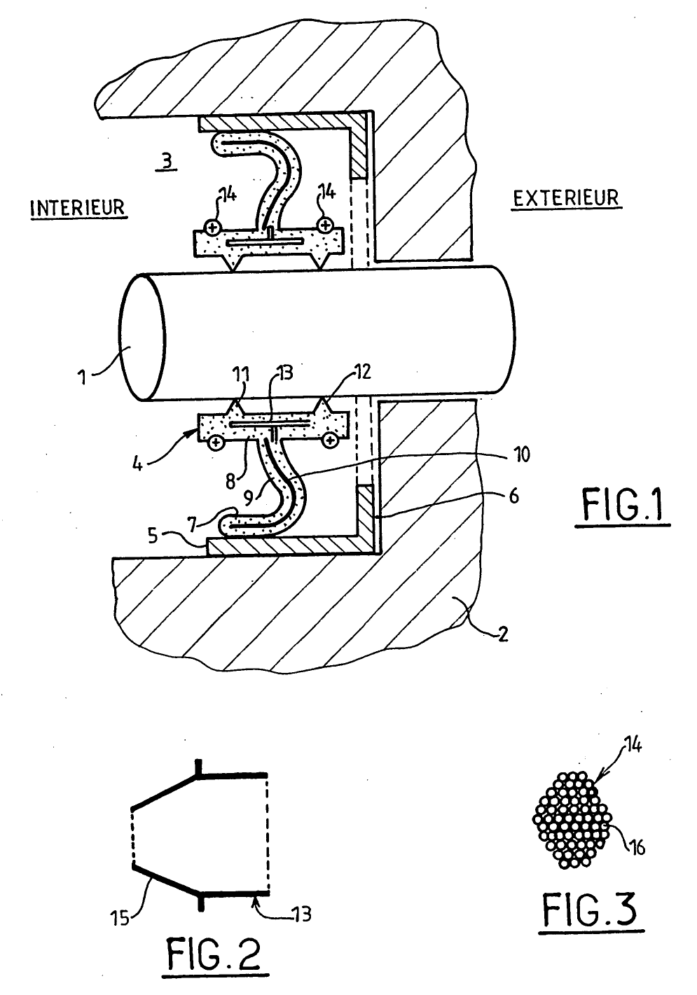

FIG. 1 is a section of the ring along the axis of rotation of the revolving shaft,

FIG. 2 is a section of the spring.

The system according to the invention is essentially applied to revolving seals used to supply pressurized fluid for the inflation or deflation of a volume, for example the pneumatic tire of a motor vehicle. In the rest of the description, the revolving shaft will be defined in its immediate environment, which may be used in any rotating system where fluid-tightness is required.

The section according to FIG. 1 is made along the axis of rotation of a revolving shaft 1 with respect to a fixed frame 2. This shaft 1 may be, for example, the wheel axle of a vehicle. According to the invention, the pressurized fluid is brought inside by the piping 3 in this revolving shaft 1 and must be prevented from escaping outwards. To this end, a ring 4 is provided that is force fitted into a casing 5, which is inserted in a housing 6 in the fixed frame 2 supporting the shaft. The Figure shows that the ring is globally U-shaped, the opening of which is turned towards the fluid inlet to the inside. The external branch 7 of the U presses in the casing 5 whereas the internal branch 8 is applied against the revolving shaft 1. This ring is made of an elastomer material of a known type and the external branch 7 and the base 9 are reinforced by a rigid framework 10, for example metallic. This framework substantially matches the shape of the branch 7 and the base 9. The internal branch 8 is made in the form of a tubular pad fitted on the shaft side with sealing lips 11 and 12 and incorporates a rigid armature 13 made in a shape memory material. This armature constitutes a deformable element as will be explained. The internal branch 8 is subjected on either side of the base 9 to the action of two springs 14 whose purpose is to apply a constant starting pressure of the pad on the revolving shaft 1. The springs 14 may be made classically or using a shape memory material such as will be explained with reference to FIG. 3. In this Figure, the deformable element 13 is in the inactive position, that is to say, it exerts no additional pressure of the branch 8 on the revolving shaft 1.

The armature 13 will deform as shown in FIG. 2 under the effect of a current and will thus press the lips 11 and 12 onto the revolving shaft 1. Thus, when sealing is required, a current is released using a classical process which does not need to be further described in order for the invention to be understood. For example, a current of 5 V may be provided which allows the temperature of the armature 13 to be raised above its point of transformation. During cooling, the armature 13 takes up its starting shape the lips 11 and 12 no longer press on the revolving shaft 1.

In the case of high pressure, operation is as follows. The pressurised fluid arrives from the inside side and exerts pressure, 10 bars, for example, on the U-shaped ring by causing the two branches to spread. Since the external branch is fixed, the internal branch will be deformed since the element 13 prevents the ring 4 from tilting.

FIG. 2 shows the armature 13 with an electric current passing through it. The armature can be seen to deform by contraction, causing a reduction in diameter of end 15. It is this reduction that enables additional pressure to be exerted and to ensure sealing.

FIG. 3 shows a section of the springs 14 made using a shape memory material. They are constituted by a coiled wire netting 16. The number of loops used depends on the stress that must be applied to perfect the sealing. The shape memory springs 14 may either constitute an alternative or a complement to the armature 13. Indeed, if the pressure that must be exerted by the ring 4 on the shaft 1 is not very high, the springs 14 alone may be used by way of a deformable element. The coils are supplied with electrical current via the same circuit used to supply the armature 13. Similarly, the action of the armature 13 may be reinforced to provided a higher level of sealing. The deformable element according to the invention may thus be constituted by the springs, by the armature 13, or else by a combination or both.

The shape memory springs enable a sealing ring to be produced incorporating a single lip for applications which pipe pressurised and depressurized fluids, where generally speaking classical double-lipped sealing rings are used.

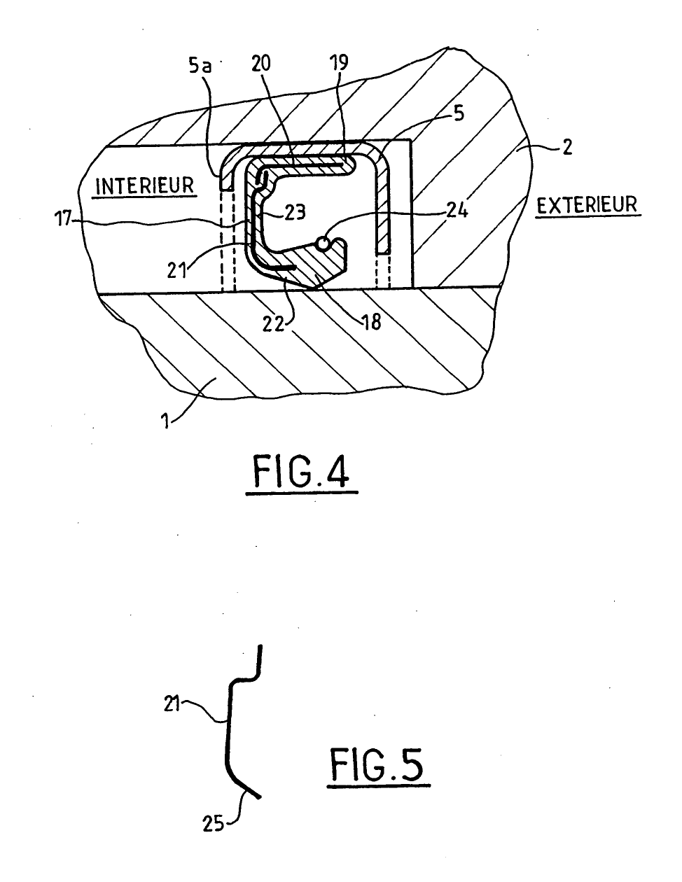

FIG. 4 shows this embodiment of the ring. The ring 17 described here is inserted as previously into a casing 5 placed between the revolving shaft 1 and the fixed frame 2. According to this embodiment, the ring 17 incorporates a single lip 18 pressing on the shaft 1. The ring 17 is also U-shaped, the concavity of which is placed in the opposite manner to that shown in FIG. 1. The external branch 19 is inserted into the casing 5 whose end 5a here is curved to constituted immobilizing means. The external branch 19 is reinforced by the metallic framework 20. The deformable element 21 or armature is here inserted in the internal branch 22 and the base 23 of the U. This element 21 is globally L-shaped. The element 21 and the armature 20 are both embedded in the elastomer mass constituting the U. The internal branch 22 is subjected to the action of a spring 24 which applies it against the revolving shaft 1. As explained previously, this spring 24 may be made of a shape memory material. In this Figure, the deformable element 21 is in its inactive position, that is to say it is not exerting any additional pressure of the branch 22 on the revolving shaft 1.

FIG. 5 shows the active position of the deformable element 21 where the end 25 can be seen to have been spread further to the passage of an electrical current to ensure that the lip 18 presses more tightly against the revolving shaft 1, so as to ensure perfect sealing as explained previously.

As described previously, the spring 24, the armature 21 or else a combination of both may be used by way of a deformable element.

1. A sealing system for a shaft revolving in a pressurized fluid circuit, wherein it comprises a sealing ring placed between the revolving shaft and a fixed casing comprising a deformable element that is applied tightly against said shaft.

2. A sealing system for a shaft revolving in a pressurized fluid circuit according to claim 1, wherein the deformable element is made of a heat-sensitive shape memory material.

3. A sealing system for a shaft revolving in a pressurized fluid circuit according to claim 2, wherein the deformable element is sensitive to a build up in temperature.

4. A sealing system for a shaft revolving in a pressurized fluid circuit according to claim 3, wherein the ring is provided with at least one lip whose deformable element directly ensures its application on to said shaft.

5. A sealing system for a shaft revolving in a pressurized fluid circuit according to claim 1, wherein the ring is in the form of a U-shaped revolving part, the deformable element being integrated in the inner branch of the U.

6. A sealing system for a shaft revolving in a pressurized fluid circuit according to claim 5, wherein the ring is force-fitted into a casing at its external branch.

7. A sealing system for a shaft revolving in a pressurized fluid circuit according to claim 4 wherein the ring only has one lip.

8. A sealing system for a shaft revolving in a pressurized fluid circuit according to claim 5, wherein the inner branch of the U is subjected to the action of a toric spring applying a starting pressure determined by the revolving shaft.

9. A sealing system for a shaft revolving in a pressurized fluid circuit according to claim 8, wherein the spring is in the form of a coil.

10. A sealing system for a shaft revolving in a pressurized fluid circuit according to claim 2, wherein the ring is in the form of a U-shaped revolving part, the deformable element being integrated in the inner branch of the U.

11. A sealing system for a shaft revolving in a pressurized fluid circuit according to claim 3, wherein the ring is in the form of a U-shaped revolving part, the deformable element being integrated in the inner branch of the U.

12. A sealing system for a shaft revolving in a pressurized fluid circuit according to claim 4, wherein the ring is in the form of a U-shaped revolving part, the deformable element being integrated in the inner branch of the U.

13. A sealing system for a shaft revolving in a pressurized fluid circuit according to claim 5, wherein the ring only has one lip.

14. A sealing system for a shaft revolving in a pressurized fluid circuit according to claim 6, wherein the ring only has one lip.

15. A sealing system for a shaft revolving in a pressurized fluid circuit according to claim 6, wherein the inner branch of the U is subjected to the action of a toric spring applying a starting pressure determined by the revolving shaft.

16. A sealing system for a shaft revolving in a pressurized fluid circuit according to claim 7, wherein the inner branch of the U is subjected to the action of a toric spring applying a starting pressure determined by the revolving shaft.
